(19) United States
(12) Patent Application Publication
(10) Pub. No.: US 2024/0173660 A1
(43) Pub. Date: May 30, 2024

(54) SYSTEMS AND TECHNIQUES FOR POLYMER PRODUCT WITHDRAWAL

(71) Applicant: Chevron Phillips Chemical Company LP, The Woodlands, TX (US)

(72) Inventors: Kenneth A. Dooley, Porter, TX (US); Jeffrey S. Lowell, Huffman, TX (US); Darrin L. Jackson, Baytown, TX (US); Tess E. Stecklein, Houston, TX (US)

(73) Assignee: Chevron Phillips Chemical Company LP, The Woodlands, TX (US)

(21) Appl. No.: 18/059,844

(22) Filed: Nov. 29, 2022

(51) Int. Cl. B01D 45/02

(52) U.S. Cl. CPC B01D 45/02

(57) ABSTRACT

A downflow polymer product withdrawal system includes a withdrawal line to collect a product including a powder and a carrier gas. The line may include at least one downward sloped descending section and is absent of any non-self draining regions. The downflow system may further include a lock hopper, a fill valve between the line and the lock hopper, and a discharge valve downstream of the lock hopper. An upflow polymer product withdrawal system includes a withdrawal line to collect and discharge a product comprising a powder and a carrier gas. The line may include at least one non-vertical section including at least one upward sloped ascending section and at least one downward sloped descending section, and is absent of any non-self draining regions. The upflow system may further include a lock hopper, a fill valve between the line and the lock hopper, and a discharge valve.

### CROSS REFERENCE TO RELATED APPLICATIONS

None.

### TECHNICAL FIELD

This disclosure relates to systems and techniques for polymerization, and in particular, to systems and techniques for withdrawing polymer product from polymerization reactors.

### BACKGROUND

Single- or multiple-reactor systems may be used to produce polymer resins, such as polyethylene. For example, polyethylene may be produced using loop slurry reactors or gas-phase reactors. The product stream includes polymer flakes or particles and reaction fluid. In continuous polymer production, it is desired to selectively increase the proportion of polymer product relative to the reaction fluid, and to substantially return withdrawn reaction fluid to the reactor, while maintaining high withdrawal density and rates. It is also desired to reduce the complexity and number of components in polymer product withdrawal systems.

A need remains for new and improved systems and processes for polymer reactor product withdrawal.

### SUMMARY OF THE DISCLOSURE

This summary is provided to introduce various concepts in a simplified form that are further described below in the detailed description. This summary is not intended to identify required or essential features of the claimed subject matter nor is the summary intended to limit the scope of the claimed subject matter.

In aspects, the present disclosure describes a downflow polymer product withdrawal system. The system includes a withdrawal line coupled to and downstream of a reactor outlet configured to collect and discharge a product including a powder and a carrier gas. The withdrawal line defines a downflow volume. The withdrawal line includes at least one downward sloped descending section. The withdrawal line is absent of any non-self draining regions. The system further includes a lock hopper coupled to and downstream of the withdrawal line. The lock hopper defines a chamber configured to receive at least a portion of the powder and the carrier gas from the withdrawal line. The system further includes a fill valve between the withdrawal line and the lock hopper, and a discharge valve downstream of the lock hopper.

In aspects, the present disclosure describes a polymerization system including a polymerization reactor having a reactor outlet configured to discharge a product comprising a powder and a carrier gas. The powder includes a polymer. The polymerization system further includes the downflow polymer product withdrawal system, coupled to the reactor outlet.

In aspects, the present disclosure describes a technique of operating a polymerization system including a polymerization reactor and a downflow polymer product withdrawal system coupled to a reactor outlet of the polymerization reactor. The technique includes opening a fill valve of the downflow polymer product withdrawal system to fluidically couple a lock hopper to the polymerization reactor through a withdrawal line. The withdrawal line includes at least one downward sloped descending section. The withdrawal line is absent of any non-self draining regions. The technique further includes, after the opening the fill valve, receiving a plug comprising powder and gas from the withdrawal line into the lock hopper. The technique further includes, after receiving the plug, allowing the lock hopper to be pressurized with gas received from the reactor through the withdrawal line to a reactor pressure. The technique further includes, after the pressurization, allowing powder from the withdrawal line to continue to settle into the lock hopper for a predetermined settling time. The technique further includes, after the settling, closing the fill valve to isolate the lock hopper from the withdrawal line and from the reactor. The technique further includes, after the closing the fill valve, opening the discharge valve to discharge the contents of the lock hopper.

In aspects, the present disclosure describes an upflow polymer product withdrawal system. The system includes a withdrawal line coupled to and downstream of a reactor outlet configured to collect and discharge a product comprising a powder and a carrier gas. The withdrawal line defines an upflow volume. The withdrawal line includes at least one non-vertical section. The non-vertical section includes at least one upward sloped ascending section and at least one downward sloped descending section. The upward sloped ascending section is downstream of the reactor. The downward sloped descending section is downstream of the upward sloped ascending section. The withdrawal line is absent of any non-self draining regions. The system further includes a lock hopper coupled to and downstream of the at least one downward sloped descending section of the withdrawal line. The lock hopper defines a chamber configured to receive at least a portion of the powder and the carrier gas from the withdrawal line. The system further includes a fill valve between the withdrawal line and the lock hopper, and a discharge valve downstream of the lock hopper.

In aspects, the present disclosure describes a polymerization system including a polymerization reactor having a reactor outlet configured to discharge a product comprising a powder and a carrier gas. The powder includes a polymer. The system includes the upflow polymer product withdrawal system, coupled to the reactor outlet.

In aspects, the present disclosure describes a technique of operating a polymerization system including a polymerization reactor and an upflow polymer product withdrawal system coupled to a reactor outlet of the polymerization reactor. The technique includes opening a fill valve of the upflow polymer product withdrawal system to fluidically couple a lock hopper of the upflow polymer product withdrawal system to the reactor through a withdrawal line. The withdrawal line includes at least one non-vertical section. The at least one non-vertical section includes at least one upward sloped ascending section and at least one downward sloped descending section. The withdrawal line is absent of any non-self draining regions. The technique further includes, after the opening the fill valve, receiving a mixture of a powder and a gas from the withdrawal line into the lock hopper and allowing the lock hopper to be pressurized to a reactor pressure. The technique further includes, after the pressurization, allowing powder from the withdrawal line to continue to settle into the lock hopper for a predetermined settling time. The technique further includes, after the settling, closing the fill valve and an equalization valve along at least one upward sloped section of the withdrawal line to isolate the lock hopper from the withdrawal line and from the reactor. The technique further includes, after the closing the fill valve, opening the discharge valve to discharge the contents of the lock hopper.

This summary and the following detailed description provide examples and are explanatory only of the disclosure. Accordingly, the foregoing summary and the following detailed description should not be considered to be restrictive. Additional features or variations thereof can be provided in addition to those set forth herein, such as for example, various feature combinations and sub-combinations of these described in the detailed description.

### BRIEF DESCRIPTION OF THE DRAWINGS

The following figures form a part of the present disclosure and are included to further demonstrate certain aspects of the present invention. The invention may be better understood by reference to one or more of these figures in combination with the detailed description of the specific embodiments presented herein.

FIG. 1 is a conceptual block diagram showing a polymerization system including a downflow polymer product withdrawal system coupled to a polymerization reactor.

FIGS. 2A to 2F are conceptual diagrams showing different stages of product withdrawal in a downflow polymer product withdrawal system. FIG. 2A is a conceptual diagram illustrating the system in an initial configuration. FIG. 2B is a conceptual diagram illustrating the system in an interim plug release configuration. FIG. 2C is a conceptual diagram illustrating the system in an interim pressurized configuration. FIG. 2D is a conceptual diagram illustrating the system in an interim solids setting configuration. FIG. 2E is a conceptual diagram illustrating the system in an interim solids release configuration. FIG. 2F is a conceptual diagram illustrating the system in a final empty configuration.

FIG. 3 is a flow diagram showing a technique for withdrawing polymer product using a downflow polymer product withdrawal system coupled to a polymerization reactor.

FIG. 4 is a conceptual block diagram showing a polymerization system including an upflow polymer product withdrawal system coupled to a polymerization reactor.

FIGS. 5A to 5D are conceptual diagrams showing different stages of product withdrawal in an upflow polymer product withdrawal system. FIG. 5A is a conceptual diagram illustrating the system in an initial configuration. FIG. 5B is a conceptual diagram illustrating the system in an interim pressurized configuration. FIG. 5C is a conceptual diagram illustrating the system in an interim settled configuration. FIG. 5D is a conceptual diagram illustrating the system in a final empty configuration.

FIG. 6 is a flow diagram showing a technique for withdrawing polymer product using an upflow polymer product withdrawal system coupled to a polymerization reactor.

FIG. 7 is a conceptual block diagram showing a polymerization system including a fluidized upflow polymer product withdrawal system coupled to a polymerization reactor.

FIGS. 8A to 8C are conceptual diagrams showing different stages of product withdrawal in a fluidized upflow polymer product withdrawal system. FIG. 8A is a conceptual diagram illustrating the system in a fluidized configuration. FIG. 8B is a conceptual diagram illustrating the system in an interim settling configuration. FIG. 8C is a conceptual diagram illustrating the system in a discharge configuration.

FIG. 9 is a flow diagram showing a technique for withdrawing polymer product using a fluidized upflow polymer product withdrawal system coupled to a polymerization reactor.

FIG. 10 is a conceptual block diagram showing a polymerization system including a continuous take-off polymer product withdrawal system coupled to a polymerization reactor.

FIG. 11 is an image showing a partial view of continuous take-off valve for use in a continuous take-off polymer product withdrawal system.

FIG. 12 is a conceptual diagram showing an interim stage of product withdrawal in a continuous take-off polymer product withdrawal system.

FIG. 13 is a flow diagram showing a technique for withdrawing polymer product using a continuous take-off polymer product withdrawal system coupled to a polymerization reactor.

FIG. 14 is a conceptual block diagram showing a polymerization system including a rotating cup polymer product withdrawal system coupled to a polymerization reactor.

FIGS. 15A and 15B are conceptual diagrams showing different stages of product withdrawal in a rotating cup polymer product withdrawal system. FIG. 15A is a conceptual diagram showing a rotating cup in a receiving configuration. FIG. 15B is a conceptual diagram showing a rotating cup in a discharge configuration.

FIG. 16 is a flow diagram showing a technique for withdrawing polymer product using a rotating cup polymer product withdrawal system coupled to a polymerization reactor.

While the inventions disclosed herein are susceptible to various modifications and alternative forms, only a few specific aspects have been shown by way of example in the drawings and are described in detail below. The figures and detailed descriptions of these specific aspects are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

It is to be understood that the disclosure is not limited in its application to the details of construction and the arrangement of components set forth in the following description or illustrated in the drawings.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

While compositions and techniques are described in terms of “comprising” various components or steps, the compositions and techniques can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” for example, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any individual substituents, analogs, compounds, ligands, structures, or groups thereof, or any members of a claimed group, if for any reason Applicant chooses to claim less than the full measure of the disclosure, for example, to account for a reference that Applicant may be unaware of at the time of the filing of the application.

For the purposes of the present disclosure, a “self-draining region” is a region of a pipe, conduit, or vessel where a passing stream completely drains through the region by the action of gravity, and substantially no residual stream component persists in the self-draining region, after closing a fill valve of the product withdrawal system.

For the purposes of the present disclosure, a “non-self draining region” is a region of a pipe, conduit, or vessel where a passing stream does not completely drain through the region by the action of gravity, and at least some residual stream component persists in the non-self draining region, after closing a fill valve of the product withdrawal system.

Although any techniques and materials similar or equivalent to those described herein can be used in the practice or testing of the invention, the typical techniques and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

The present disclosure generally relates to systems and techniques for polymerization, and in particular, to systems and techniques for withdrawing polymer product from reactors. For example, polyolefin may be produced as polyolefin flakes or particles carried in a reaction fluid. Systems and techniques according to the present disclosure may be used to withdraw polymer product, for example, dispersed, particular, flake, or other polymer product, from a polymerization reactor, for example, during continuous operation and polymer production in the polymerization reactor.

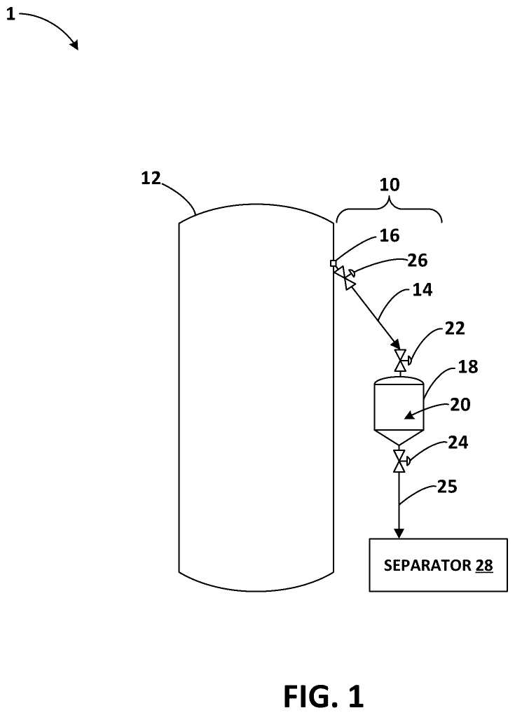

FIG. 1 is a conceptual block diagram showing a polymerization system 1 including a downflow polymer product withdrawal system 10 coupled to a polymerization reactor 12. The system 10 includes a withdrawal line 14 coupled to and downstream of a reactor outlet 16 of the reactor. The withdrawal line 14 may be directly coupled to the outlet 16, or coupled by an intervening element. For example, system 10 may further include an eructation tube configured to couple a top of the withdrawal line 14 to an above-bed or lower pressure outlet of the reactor.

The reactor outlet 16 is configured to collect and discharge a product including a powder and a carrier gas. The powder includes a polymer. The polymerization reactor 12 may be any suitable polymerization reactor, and the polymer product may include any polymer, for example, in a powder, flake, or particulate form. In aspects, the polymerization reactor may be a polyolefin reactor, and the polymer product may include a polyolefin. In some such aspects, the polyolefin may include a polyethylene or a poly propylene. The polymerization reactor 12 may include a single reactor, or may include multiple reactors connected in series and/or parallel. In aspects, the polymerization reactor 12 includes a gas-phase polyolefin reactor or a loop-slurry polyolefin reactor.

The withdrawal line 14 defines a downflow volume. The withdrawal line 14 includes at least one downward sloped descending section, as shown in FIG. 1. The withdrawal line 14 is absent of any non-self draining regions. For example, no region may be present in withdrawal line 14 where any polymer product collects or remains after passage of a stream including the polymer product.

The downflow volume of the withdrawal line 14 may be sized to collect and retain sufficient product to promote subsequent densification in the lock hopper 18. In aspects, the downflow volume is greater than 80% of a volume of the lock hopper 18 (for example, of chamber 20). In some such aspects, the downflow volume is greater than 90% of the volume of the lock hopper 18. In some such aspects, the downflow volume is 100% or less of the volume of the lock hopper 18. In some such aspects, the downflow volume is substantially 100% of the volume of the lock hopper 18. Without being bound by theory, providing a downflow volume that is substantially the same or somewhat lower than the volume of the lock hopper 18 may avoid agglomeration of product left in the withdrawal line 14 between a sequence of withdrawals or during multiple withdrawals.

The withdrawal line 14 may have any suitable cross-section, for example, a circular or ellipsoidal cross-section, or any curved or linear portions or combinations thereof. Thus, in aspects, the downward sloped descending section of the withdrawal line 14 may be substantially cylindrical. In aspects, the withdrawal line 14 consists of the at least downward sloped descending section. In aspects, the withdrawal line 14 may include one, two, or more downward sloped descending sections. In aspects, the withdrawal line 14 includes only a single downward sloped descending section.

In aspects, the withdrawal line 14 is absent of any vertical sections. In aspects, the withdrawal line is absent of any substantially vertical sections. Avoiding vertical sections may reduce or prevent powder fluidizing in the withdrawal line 14 (which may slow powder flow), and substantially permit the upward flow of residual gas past downward flowing powder back to the reactor 12. For example, each portion of the withdrawal line 14 may be sloped away from a vertical direction relative to gravity by at least 5 degrees, or at least 10 degrees, or at least 15 degrees, or at least 20 degrees, or at least 25 degrees, or at least 30 degrees.

In aspects, the withdrawal line 14 is absent of any bends. For example, the withdrawal line 14 may extend along a substantially straight line. Without being bound by theory, avoiding bends may reduce or prevent product accumulation or agglomeration in the withdrawal line 14.

In aspects, the at least one downward sloped descending section defines a slope relative to a vertical axis greater than or equal to 10 degrees. In aspects, the slope is less than or equal to 30 degrees. In some aspects, the slope is greater than an angle of repose of the polymer product. In some aspects, the slope is greater than a critical chute angle. Without being bound by theory, providing a slope greater than one or both of the angle of repose or the critical chute angle may reduce or prevent product accumulation or agglomeration in the withdrawal line 14. For example, the slope may permit carrier gas in the withdrawal line to flow upward and above polymer product or powder in the withdrawal line flowing downward from the reactor.

The system 10 further includes a lock hopper 18 coupled to and downstream of the withdrawal line 14. The lock hopper 18 defines a chamber 20 configured to receive at least a portion of the powder and the carrier gas from the withdrawal line 14. The lock hopper 18 may be formed of metal or alloy, and have any suitable shape and size. In aspects, the lock hopper 18 may include a cylindrical top section joined to a conical bottom section. A center of the conical bottom section may be aligned with or offset from that of the cylindrical top section. The same axis may extend through centers of both the cylindrical top section and the conical bottom section. Thus, the chamber 20 may be defined by the cylindrical top section and the conical bottom section. The cylindrical top shape may promote the collection and retention of a relatively high density of collected product, and the conical bottom shape may promote subsequent discharge of the product from the lock hopper 18. In some aspects, the conical bottom section may be a partial conic section, for example, a half-conical section or an eccentric conic section.

The system 10 further includes a fill valve 22 between the withdrawal line 14 and the lock hopper 18, and a discharge valve 24 downstream of the lock hopper 18. The fill valve 22 and the discharge valve 24 may include any suitable valve for allowing or blocking flow of a stream including polymer product, such as a powder, flake, or particulate, in a carrier fluid, such as a gas.

In aspects, the lock hopper axis extends along a vertical axis. In some aspects, one or both of the fill valve 22 and the discharge valve 24 extend along a vertical axis, as shown in FIG. 1. Providing a vertical orientation to the lock hopper 18 may promote relatively rapid settling, and promote densification of polymer product collected in the lock hopper 18. Providing the fill valve 22 and the discharge valve 24 in a vertical orientation may promote rapid flow of the polymer product and reduce plugging or agglomeration.

In aspects, a flow diameter of one or both of the fill valve 22 and the discharge valve 24 is greater than or equal to a flow diameter of the withdrawal line 14. In some aspects, a flow diameter of one or both of the fill valve 22 and the discharge valve 24 is the same as a flow diameter of the withdrawal line 14.

The polymer product collected in the lock hopper 18 may be periodically discharged. For example, system 10 may further include a discharge line 25 coupled to the discharge valve 24. In some aspects, the discharge line 25 is absent of bends. Avoiding excessive bends in the discharge line 25 may reduce or prevent skin formation associated with high temperatures arising from friction at bends. Using a relatively short length for the discharge line 25 may also promote increased withdrawal rates.

System 10 may further include a reactor outlet valve 26 along the withdrawal line 14 and adjacent the reactor outlet 16. In some aspects, the reactor outlet valve 26 is a ram valve configured to seals flow at the reactor internal diameter to prevent plugging of the reactor nozzle when the withdrawal line 14 is not in service but the reactor 12 is operating. The reactor outlet valve 26 may be opened to release material and pressure withdrawal line 14 to the pressure of the reactor 12, and closed to isolate withdrawal line 14 from the reactor 12.

The polymerization system 1 may further include a separator 28 coupled to the downflow polymer product withdrawal system 10. For example, the separator 28 may be a gas-particulate separator to reduce or remove residual gas carried with the polymer product.

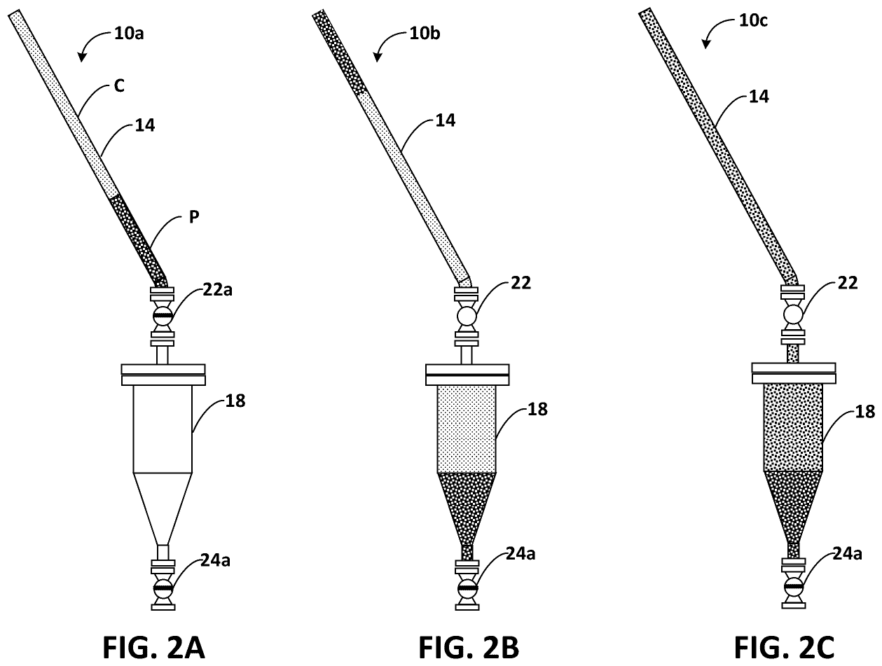

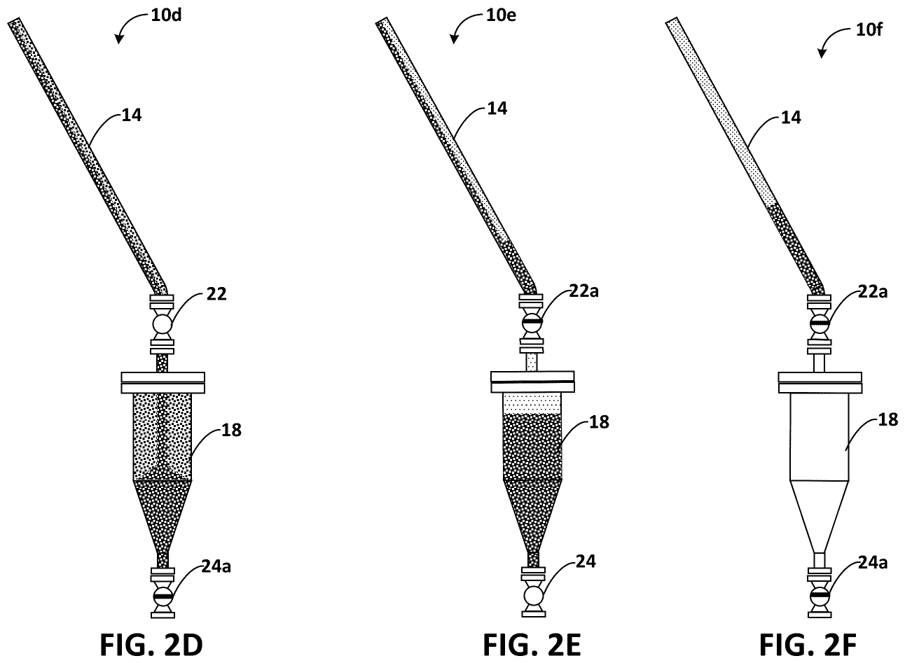

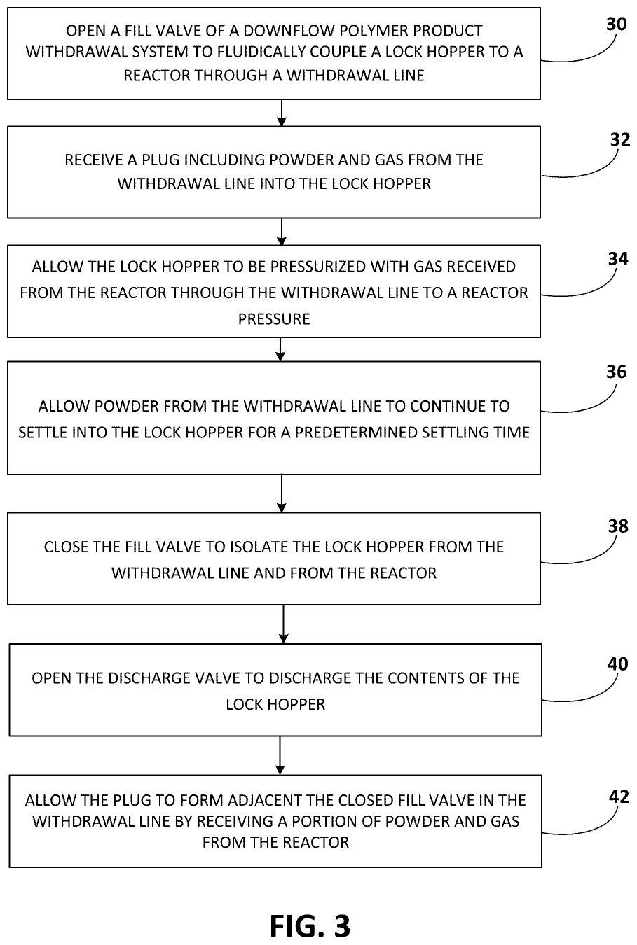

The operation of the downflow polymer product withdrawal system 10 of polymerization system 1 is described with reference to FIGS. 2A to 2F, and FIG. 3.

FIGS. 2A to 2F are conceptual diagrams showing different stages of product withdrawal in a downflow polymer product withdrawal system, for example, system 10 of FIG. 1. In FIGS. 2A to 2F, one or both of the valves 22 and 24 are either in closed positions 22a or 24a, or in open positions.

FIG. 2A is a conceptual diagram illustrating the system in an initial configuration 10a. In the initial configuration 10a, a plug P is present accumulated against closed fill valve 22a in the withdrawal line 14. The plug P may be formed in a previous withdrawal cycle, by residual solids left in the withdrawal line 14, and due to settling of reactor contents into the withdrawal line 14. The plug P may substantially have settled bulk density of solids (polymer product). A volume upstream of the plug P in the withdrawal line may include a solid concentration C. Because the plug P is relatively dense and immobile, the solid concentration C remains stable behind plug P in the initial configuration 10a. The lock hopper 18 is substantially empty of polymer product, and discharge valve 24a is also closed. Some residual gas from a previous withdrawal cycle may remain in the lock hopper 18, providing a slight positive pressure. In aspects, the positive pressure may be about 10 psig.

FIG. 2B is a conceptual diagram illustrating the system in an interim plug release configuration 10b. The configuration 10b is achieved by leaving discharge valve 24a closed, but opening the fill valve 22, to allow the plug P to be released from the withdrawal line and to flow into the lock hopper 18. Thus, the contents of the plug P now pass to the lock hopper 18, and substantially accumulate at a bottom of the lock hopper 18. For example, the contents of the plug P may now occupy a conical bottom portion of the lock hopper 18. In some aspects, the plug P occupies a major fraction of a volume of the lock hopper 18.

As the plug P moves into the lock hopper 18, gas and solids may move from the reactor outlet 16 into the withdrawal line 14. This may occur at a solids concentration that is a fraction (for example, 60 to 100%, or another proportion that may depend on the permeability of the solids) of the solids concentration in the reactor 12. This volume will expand across the line in order to push the rest of the original contents of the line into the pot (plug P plus volume C behind plug). This volume, expanded to the line volume, represents the initial solids concentration (“concentration 1”) in the line as the lock hopper 18 begins to pressurize.

Gas from the plug P and that associated with the solids content C initially behind the plug P may now expand along the withdrawal line 14 and into the lock hopper 18, to pressurize the lock hopper 18.

FIG. 2C is a conceptual diagram illustrating the system in an interim pressurized configuration 10c. The fill valve 22 remains open, with discharge valve 24a closed. The lock hopper 18 pressurizes to the full reactor pressure, bringing a mixture that is a fraction of the reactor fluidized bed density. For example, the fraction may be an average of concentration 1 and 40% to 90% of the reactor solids concentration, or another fraction that depends on the permeability of the solids.

FIG. 2D is a conceptual diagram illustrating the system in an interim solids setting configuration 10d. The fill valve 22 remains open, with discharge valve 24a closed. After the lock hopper 18 is fully pressurized, solids continue to settle into the pot for the remainder of the time the fill valve 22 is left open. The accumulated solids in the lock hopper 18 are a combination of solids from the plug P, solids from the volume C behind the plug, solids from the final pressurization, and solids that settle after pressurization. Eventually, a majority of the lock hopper 18 may be occupied by solids. For example, more than 50%, or more than 60%, or more than 70%, or more than 80%, or more than 90%, or more than 95%, of the volume of the lock hopper 18, may be occupied by a bulk density of solids.

The settling rates may be related to values approaching minimum fluidization velocities in vertical sections of the piping. However, providing a slope in the withdrawal line 14 may allow solids to slide along the bottom of the withdrawal line 14 as gas passes over the top, increasing settling rates compared to those in vertical sections. This may play a substantial role in the size of the plug in the withdrawal line 14, especially at low withdrawal frequencies when time for settling is largest. If the settling rate is high or the initial plug size is large, the effect of withdrawal speed may be reduced.

The optional use of an eructation or “burp” tube connecting a top of the withdrawal line 14 to a location above a reaction bed in the reactor 12 may improve settling rates from the reactor 12.

If the plug size can be made to approach or exceed the amount of solids the lock hopper 18 can hold, then the efficiency of the withdrawal may increase (lbs solids per withdrawal). The initial plug size may be impacted by the volume of the withdrawal line 14 relative to the lock hopper. As the volume of the withdrawal line 14 approaches or slightly exceeds the volume of the lock hopper 18, this can be achieved. However, if the volume of the withdrawal line 14 greatly exceeds the volume of the lock hopper 18, material may be left in the withdrawal line 14 between individual withdrawals for multiple withdrawals, and may lead to agglomeration in the withdrawal line 14.

FIG. 2E is a conceptual diagram illustrating the system in an interim solids release configuration 10c. The fill valve 22a is now closed, and the discharge valve 24 is opened. The accumulated solids are discharged from the lock hopper 18. The lock hopper may substantially empty the solids into the discharge line 25, or into separator 28, or otherwise for further treatment, storage, packaging, or transportation. Because fill valve 22a is closed, solids already in the withdrawal line 14 settle in the line to begin forming a plug for the next cycle. Additional solids settle from the reactor 12 into the withdrawal line 14.

FIG. 2F is a conceptual diagram illustrating the system in a final empty configuration 10f. Now, discharge valve 24a is closed, and fill valve 22a remains closed. The lock hopper 18 is substantially empty of solids. Some residual gas pressure, for example, 10 psig may be present in the lock hopper 18. The configuration 10f of FIG. 2F now forms the initial configuration for the next withdrawal cycle, and the withdrawal cycles can be continued.

FIG. 3 is a flow diagram showing a technique for withdrawing polymer product using a downflow polymer product withdrawal system coupled to a polymerization reactor. While the technique of FIG. 3 is described with reference to the polymerization system 1 of FIG. 1, and the various states of the downflow polymer product withdrawal system 10a to 10f described with reference to FIGS. 2A to 2F, the technique may be practiced using any suitable system according to the present disclosure.

At step 30, the technique includes opening a fill valve 22 of the downflow polymer product withdrawal system 10 to fluidically couple a lock hopper 18 to the reactor 12 through the withdrawal line 14 (for example, beginning with the configuration 10a described with reference to FIG. 2A, opening the fill valve 22).

At step 32, the technique further includes, after the opening the fill valve 22 (30), receiving a plug P including powder and gas from the withdrawal line 14 into the lock hopper 18 (for example, configuration 10b described with reference to FIG. 2B).

At step 34, the technique further includes, after receiving the plug P (32), allowing the lock hopper 18 to be pressurized with gas received from the reactor 12 through the withdrawal line 14 to a reactor pressure (for example, configuration 10c described with reference to FIG. 2C).

At step 36, the technique further includes, after the pressurization (34), allowing powder from the withdrawal line 14 to continue to settle into the lock hopper 18 for a predetermined settling time (for example, configuration 10d described with reference to FIG. 2D).

At step 38, the technique further includes, after the settling (36), closing the fill valve 22 to isolate the lock hopper 18 from the withdrawal line 14 and from the reactor 12 (for example, configuration 10e described with reference to FIG. 2E). In aspects, after the settling (36), the lock hopper 18 has a solids concentration greater than a solids concentration in the reactor 12.

At step 40, the technique further includes, after the closing the fill valve 22b, opening the discharge valve 24 to discharge the contents of the lock hopper 18 (for example, configuration 10e described with reference to FIG. 2E).

At step 42, the technique further includes allowing the plug P to form adjacent the closed fill valve 22b in the withdrawal line 14 by receiving a portion of powder and gas from the reactor 12. In aspects, the plug P has a solids concentration from 60% to 150% by weight of a solids concentration in the reactor 12.

The technique may further include repeating any of steps 30 to 42 one or more times.

In aspects, a withdrawn bulk density of material discharged from the downflow polymer product withdrawal system 10 is greater than 16 lbs/ft³ withdrawal bulk density when the reactor fluid bulk density is 15 lbs/ft³.

Thus, the downflow polymer product withdrawal system 10 may be used to advantageously withdraw polymer product from the reactor 12 with repeated withdrawal cycles.

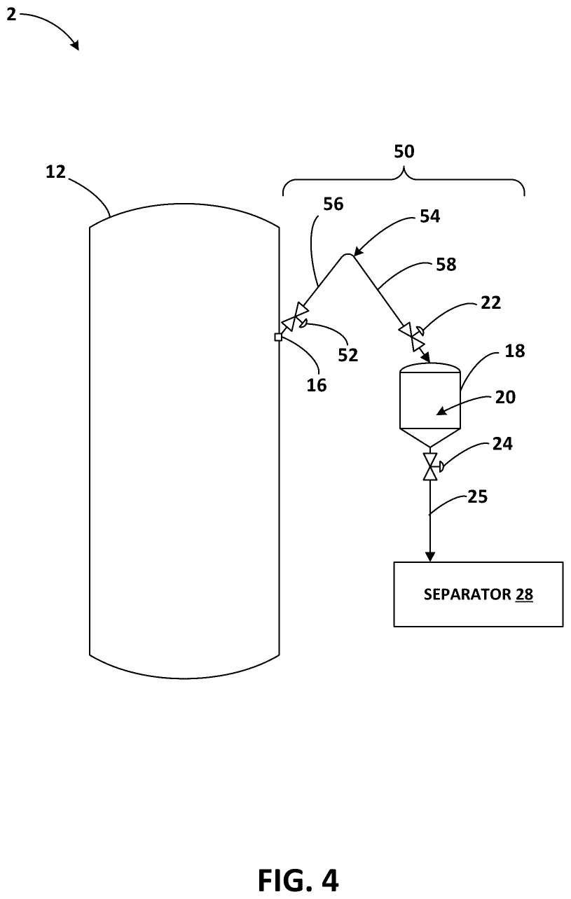

Additional withdrawal systems and techniques are described with reference to FIGS. 4 to 16. Where the components are numbered the same as components described with reference to FIGS. 1 to 3, their structure and function is substantially the same as described with reference to FIGS. 1 to 3.

FIG. 4 is a conceptual block diagram showing a polymerization system 2 including an upflow polymer product withdrawal system 50 coupled to the polymerization reactor 12. The system 50 is coupled to the reactor outlet 16 of reactor 12. The position of the reactor outlet 16 may be the same or different from that in system 1 of FIG. 1.

The system 50 includes a withdrawal line 54 coupled to and downstream of the reactor outlet 16 configured to collect and discharge a product including a powder and a carrier gas. The system 50 may further include an eructation tube configured to couple a top of the withdrawal line 54 to a lower pressure region of the reactor 12.

The withdrawal line 54 defines an upflow volume. The withdrawal line 54 includes at least one non-vertical section. For example, the non-vertical section includes at least one upward sloped ascending section 56 and at least one downward sloped descending section 58. In some aspects, the upflow volume is defined only by the downward sloped descending section 58. The upward sloped ascending section 56 is downstream of the reactor 12 and, the downward sloped descending section 58 is downstream of the upward sloped ascending section. The withdrawal line 54 is absent of any non-self draining regions.

The system 50 includes the lock hopper 18 coupled to and downstream of the at least one downward sloped descending section 58 of the withdrawal line 54. The lock hopper defines the chamber 20 configured to receive at least a portion of the powder and the carrier gas from the withdrawal line 54.

The upflow volume and the volume of the lock hopper 18 may be provided such that the sum of the upflow volume (for example, a volume of the downward sloped descending section 58) and the lock hopper volume is sufficient to hold enough solids at a “transferred” solids concentration, to completely fill the lock hopper volume with solids at a “settled” (for example, bulk density) solids concentration.

The system 50 includes the fill valve 22 between the withdrawal line 54 and the lock hopper 18. In aspects, the fill valve 22 is located along the downward sloped descending section 58, or at the end of the downward sloped descending section 58. The system 50 includes the discharge valve 24 downstream of the lock hopper 18.

The system 50 may include a reactor isolation valve 52 along the at least one upward sloped ascending section 56. In aspects, the reactor isolation valve 52 is located at or adjacent an end of at least one upward sloped ascending section 56. In aspects, the reactor isolation valve 52 is coupled to the reactor outlet 16. The reactor isolation valve 52 may be a ram valve.

In aspects, the upflow volume is less than or equal to 50% of a volume of the lock hopper 18. In aspects, the upflow volume is greater than 25% of the volume of the lock hopper 18. In aspects, the upflow volume is in a range from 25% to 50% of the volume of the lock hopper 18.

To reduce or prevent agglomeration or plugging, and to allow or promote an upward flow of gas toward the reactor 12 above settled solids along the withdrawal line 54, the withdrawal line 54 may be absent of any vertical sections. The withdrawal line 54 may be absent of any substantially vertical sections.

In aspects, the at least one upward sloped ascending section 56 defines an ascending slope relative to a vertical axis greater than or equal to 10 degrees. In aspects, the at least one downward sloped descending section 58 defines a descending slope relative to a vertical axis greater than or equal to 10 degrees. In some aspects, one or both of the ascending slope and the descending slope is less than or equal to 30 degrees. In some aspects, one or both of the ascending slope and the descending slope is greater than one or both of a critical chute angle or an angle of repose of the polymer product. In some aspects, the ascending slope is substantially equal to the descending slope. In aspects, the descending slope permits carrier gas in the withdrawal line 54 to flow upward and above powder in the withdrawal line 54 flowing downward from the reactor 12.

In aspects, the withdrawal line 54 has a cross-section similar to that described with reference to the withdrawal line 14 of system 1. In some aspects, the sloped sections of the withdrawal line 54 are cylindrical. In some aspects, the withdrawal line consists of the sloped sections. In aspects, the sloped sections are absent of any bends.

One or both of the lock hopper 18 and the discharge valve 24 may extend along a vertical axis, while the fill valve 22 may be inclined relative to the vertical axis, as shown in FIG. 4. In aspects, a flow diameter of one or both of the fill valve 22 and the discharge valve 24 is greater than or equal to a flow diameter of the withdrawal line 54. In aspects, a flow diameter of one or both of the fill valve 22 and the discharge valve 24 is the same as a flow diameter of the withdrawal line 54. Such a configuration may reduce or prevent clogging or flow reduction across these components.

System 50 may further include the discharge line 25 coupled to the discharge valve 24. The polymerization system 2 may further include the separator 28 coupled to the upflow polymer product withdrawal system 50.

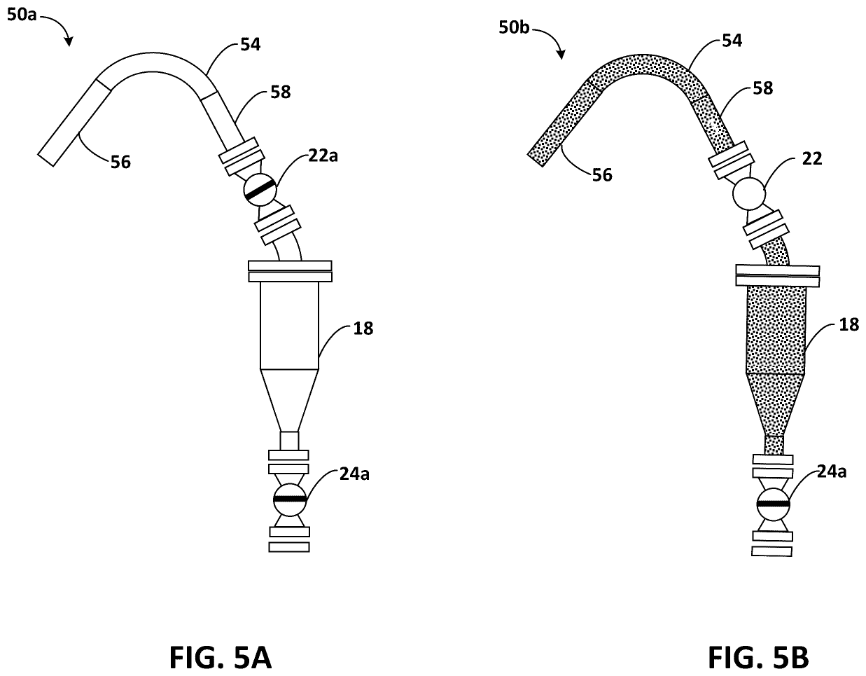

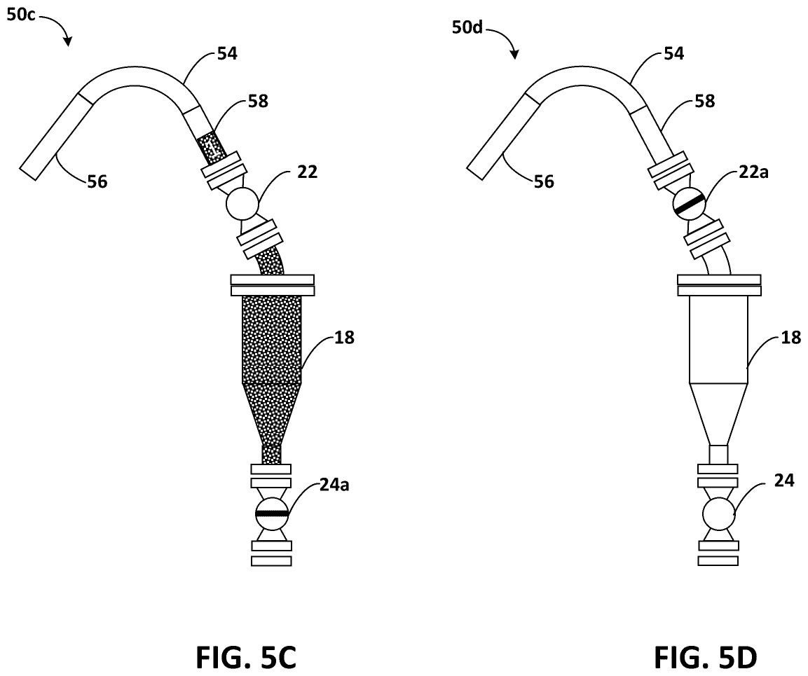

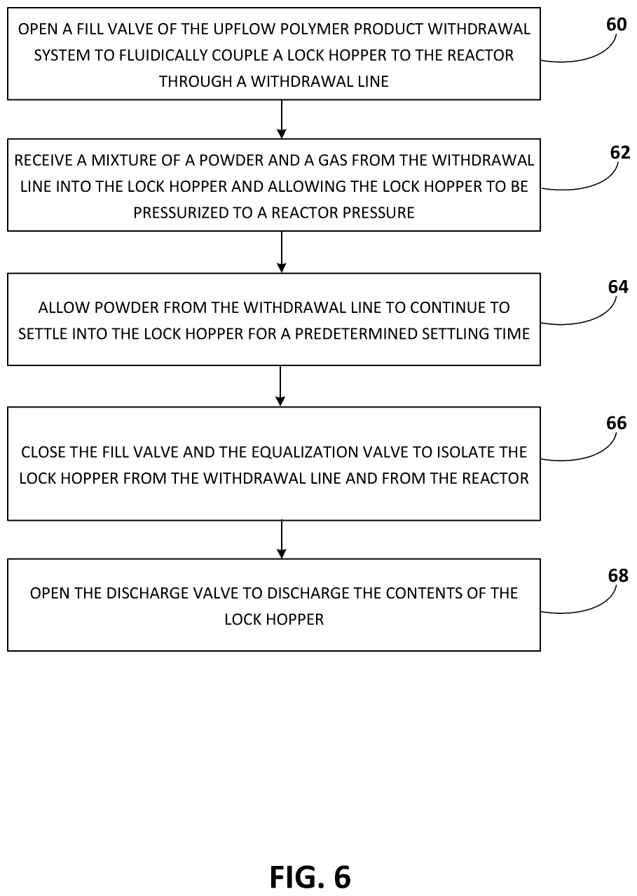

The operation of the upflow polymer product withdrawal system 10 of polymerization system 1 is described with reference to FIGS. 5A to 5D, and FIG. 6.

FIGS. 5A to 5D are conceptual diagrams showing different stages of product withdrawal in the upflow polymer product withdrawal system 50. In FIGS. 5A to 5D, one or both of the valves 22 and 24 are either in closed positions 22a or 24a, or in open positions.

FIG. 5A is a conceptual diagram illustrating the system in an initial configuration 50a. In the initial configuration 50a, lock hopper 18 is substantially empty of the polymer product, and residual gas from a previous withdrawal cycle leaves a slight positive pressure in the lock hopper 18. For example, the residual pressure may be about 10 psig. Both fill valve 22a and discharge valve 22a are closed. The system is now ready to commence a new withdrawal cycle.

FIG. 5B is a conceptual diagram illustrating the system in an interim pressurized configuration 50b. In the interim configuration 50b, the fill valve 22 is opened, allowing gas and solids to enter and pressurize the lock hopper 18. The discharge valve 24a remains closed. The mixture is at or below the solids concentration in the reactor.

FIG. 5C is a conceptual diagram illustrating the system in an interim settled configuration 50c. In the interim configuration 50c, the fill valve 22 remains open, and the discharge valve 24a remains closed, which allows the lock hopper to attain reactor pressure. The solids in the upflow volume and in the lock hopper 18 settle in the lock hopper. After a sufficient settling time, the fill valve 22a is closed to isolate the lock hopper 18 from the withdrawal line 54 and the reactor 12, and the discharge valve 24 is opened to allow the settled solids to be discharged from the lock hopper 18, leading to the final configuration of FIG. 5D.

FIG. 5D is a conceptual diagram illustrating the system in a final empty configuration 50d. In the final empty configuration, substantially no solids are present in the lock hopper 18. Closing the discharge valve 24 cycles the system to the initial configuration 50a, ready for the next withdrawal cycle.

FIG. 6 is a flow diagram showing a technique for withdrawing polymer product using an upflow polymer product withdrawal system coupled to a polymerization reactor. While the technique of FIG. 6 is described with reference to the polymerization system 2 of FIG. 4, and the various states of the upflow polymer product withdrawal system 50a to 50d described with reference to FIGS. 5A to 5D, the technique may be practiced using any suitable system according to the present disclosure.

At step 60, the technique includes opening the fill valve 22 of the upflow polymer product withdrawal system 50 to fluidically couple the lock hopper 18 to the reactor 12 through the withdrawal line 54 (for example, beginning with the configuration 50a described with reference to FIG. 5A, opening the fill valve 22).

At step 62, the technique further includes, after the opening the fill valve 22 (60), receiving a mixture of a powder and a gas from the withdrawal line 54 into the lock hopper 18 and allowing the lock hopper 18 to be pressurized to a reactor pressure (for example, configuration 50b described with reference to FIG. 5B).

At step 64, the technique further includes, after the pressurization (62), allowing powder from the withdrawal line to continue to settle into the lock hopper 18 for a predetermined settling time (for example, configuration 50c described with reference to FIG. 5C). In aspects, after the settling (64), the reactor isolation valve 52 is closed before the fill valve 22 is closed. The lock hopper 18 may be substantially completely occupied by settled solids after the settling (64).

At step 66, the technique further includes, after the settling (64), closing the fill valve 22 and the reactor isolation valve 52 to isolate the lock hopper 18 from the withdrawal line 54 and from the reactor 12 (for example, after the configuration 50c described with reference to FIG. 5C).

At step 68, the technique further includes, after the closing the fill valve (66), opening the discharge valve 24 to discharge the contents of the lock hopper 18 (just before the configuration 50d described with reference to FIG. 5D). In some aspects, the valve 24 may be closed before proceeding to the next cycle.

In aspects, the mixture in the lock hopper has a solids concentration equal to or greater than a solids concentration in the reactor.

In aspects, the technique includes repeating the steps 60 to 68 one or more times.

In aspects, a withdrawn bulk density of material discharged from the upflow polymer product withdrawal system is greater than or equal to 16 lbs/ft³ withdrawal bulk density while the reactor fluid bulk density is 15 lbs/ft³.

Thus, the upflow polymer product withdrawal system 50 may be used to advantageously withdraw polymer product from the reactor 12 with repeated withdrawal cycles.

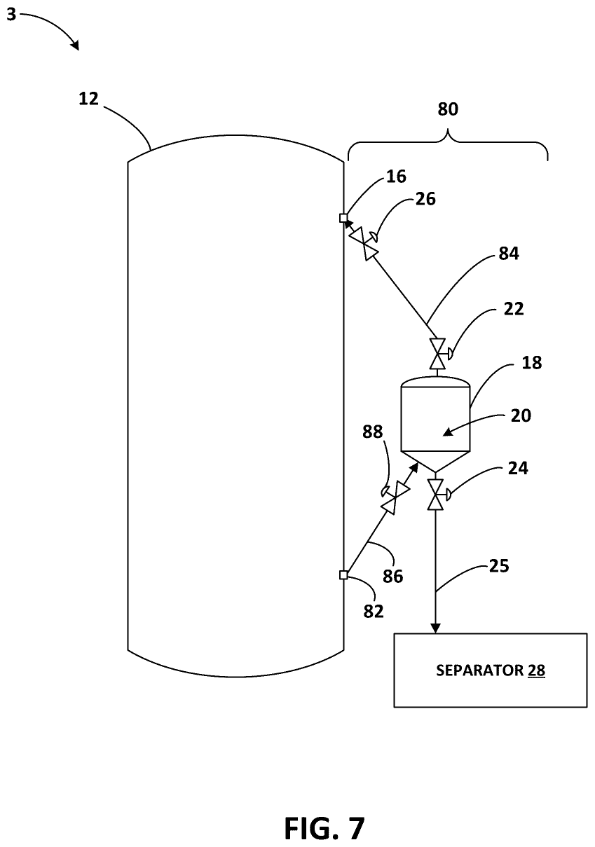

FIG. 7 is a conceptual block diagram showing a polymerization system 3 including a fluidized upflow polymer product withdrawal system 80 coupled to the polymerization reactor 12. The system 80 is coupled between the upper or lower pressure reactor outlet 16 of reactor 12, and a lower or higher pressure reactor outlet 82. The position of the reactor outlet 16 may be the same or different from that in system 1 of FIG. 1.

The system 80 includes an upper withdrawal line 84 coupled to the upper reactor outlet 16 configured to collect and discharge a product including a powder and a carrier gas. The system 3 may further include an eructation tube configured to couple a top of the upper withdrawal line 84 to an above-bed or lower pressure outlet of the reactor 12. The upper withdrawal line 84 defines an upper upflow volume. The upper withdrawal line 84 includes at least one descending non-vertical section. The upper withdrawal line 84 is absent of any non-self draining regions. The upper withdrawal line 84 may be absent of any substantially vertical sections.

The system 80 includes the lock hopper 18 coupled to and downstream of the upper withdrawal line 84. The lock hopper 18 defines the chamber 20 configured to receive at least a portion of the powder and the carrier gas from the upper withdrawal line 84.

The system 80 further includes a lower withdrawal line 86 coupled to and downstream of the lock hopper 18. The lower withdrawal line 86 is coupled to the lower reactor outlet 82 configured to collect and discharge the product. The lower withdrawal line 86 includes at least one ascending section. The ascending section may be vertical or sloped at an ascending angle from 0 degrees to 20 degrees from the vertical.

The diameter of the lock hopper 18 be provided such that minimum fluidization is maintained when a flow path established through the lock hopper 18 along the lower withdrawal line 86 and the upper withdrawal line 84. In aspects, the diameter of the lock hopper may be between d and 3×d, or between d and 1.5×d, where d is the withdrawal line diameter (either the upper line or the lower line). In some aspects, both the upper withdrawal line 84 and the lower withdrawal line 86 have substantially the same diameter.

The system 80 includes at least one upper fill valve 22 between the upper withdrawal line and the lock hopper. The system 80 includes a lower fill valve 88 between the lock hopper and the lower withdrawal line 86, and the discharge valve 24 for discharging the contents of the lock hopper. In aspects, a flow diameter of the upper fill valve 22 is greater than or equal to a flow diameter of the upper withdrawal line 84 and a flow diameter of the lower fill valve 88 is greater than or equal to a flow diameter of the lower withdrawal line 86. In some aspects, a flow diameter of the upper fill valve 22 is the same as a flow diameter of the upper withdrawal line 84 and a flow diameter of the lower fill valve 88 is the same as a flow diameter of the lower withdrawal line 86. The system 80 may further include the reactor outlet valve 26 between the upper reactor outlet 12 and the upper withdrawal line 84.

In aspects, the upper reactor outlet 16 is positioned from 60% to 100% of a fluidized bed height of the reactor 12. In aspects, the lower reactor outlet 82 is positioned from 0% to 30% of the fluidized bed height of the reactor 12.

The upper upflow volume may be less than or equal to 50% of a volume of the lock hopper. Without being bound by theory, not exceeding 50% of the volume of the lock hopper may permit the upper upflow volume to minimize solids inventory left in the withdrawal line 84 at the end of settling. The upper upflow volume may be greater than 25% of the volume of the lock hopper 18. Such a volume may help account for the difference in the settled bulk density of the polymer product and the fluidized bulk density at reactor conditions.

To promote flow of gas back to the reactor 12 over a stream of downward flowing solids, and reduce or prevent plugging or agglomeration, the upper withdrawal line 84 may be absent of any vertical sections.

In aspects, the descending non-vertical section defines a descending slope relative to a vertical axis greater than or equal to 10 degrees. In aspects, the descending slope is less than or equal to 30 degrees. In aspects, the descending slope is greater than one or both of a critical chute angle or an angle of repose of the polymer product.

One or both of the upper withdrawal line 84 and the lower withdrawal line 86 may have a cross-section as described with reference to the withdrawal line 14 of system 1. For example, one or both of the ascending section and the descending non-vertical section may be cylindrical.

In aspects, one or both of the ascending section and the descending non-vertical section are absent of any bends.

The system 3 may further include the discharge line 25 coupled to the discharge valve 24, and may further include the separator 28.

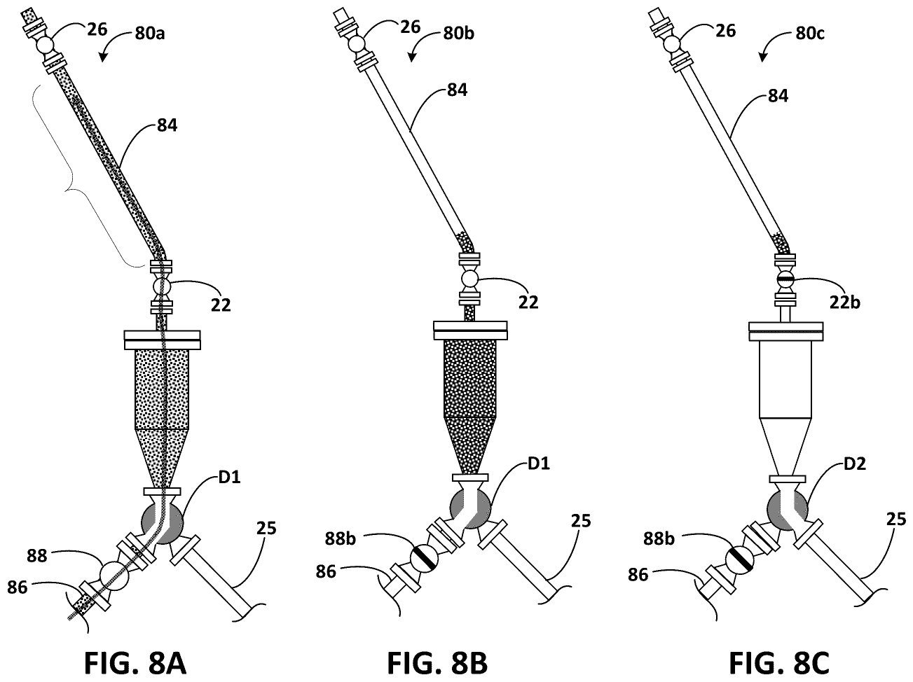

In aspects, the discharge valve 25 is a diverter valve D (shown in FIGS. 8A to 8C) coupled to and downstream of the lock hopper 18. The diverter valve D may be coupled to the downstream discharge line 25. The diverter valve may have a withdrawal position D1 coupling the lock hopper 18 to the lower withdrawal line 86 and a discharge position D2 coupling the lock hopper 18 to the downstream discharge line 25.

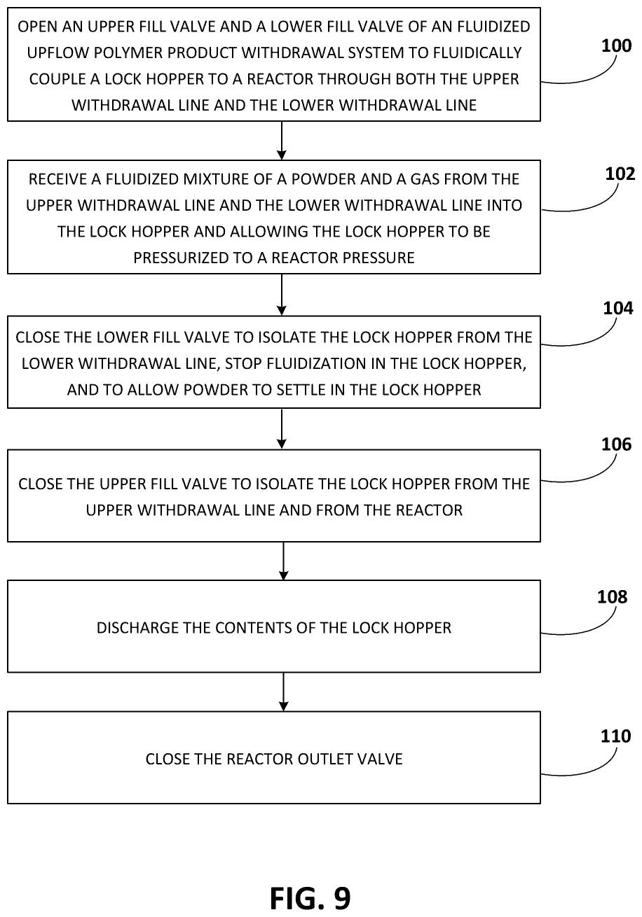

The operation of the fluidized upflow product withdrawal system 80 of polymerization system 3 is described with reference to FIGS. 8A to 8C, and FIG. 9.

FIGS. 8A to 8C are conceptual diagrams showing different stages of product withdrawal in the fluidized upflow polymer product withdrawal system 80.

FIG. 8A is a conceptual diagram illustrating the system in a fluidized configuration 80a. In the configuration 80a, the diverter valve is in configuration D1, and exposes the chamber 20 of the lock hopper 18 to the upper withdrawal line 84 and the lower withdrawal line 86. Upper fill valve 22, nozzle valve 26, and lower fill valve 88 are each open, allowing a fluidized stream to flow from the lower or higher pressure reactor outlet 82 to the upper reactor outlet 16. Solids and gas are introduced through the fluidization through the lock hopper 18.

FIG. 8B is a conceptual diagram illustrating the system in an interim settling configuration 80b. In the configuration 80b, the diverter valve is in the same configuration D1, and the upper fill valve 22 and nozzle valve 26 remains open, however, the lower fill valve 88b is closed. Such a configuration stops fluidization through the lower withdrawal line 86, and the solids settle in the lock hopper 18 close to a settled bulk density, while residual gas flows upward and back to the reactor 12 through the upper withdrawal line 84.

FIG. 8C is a conceptual diagram illustrating the system in a discharge configuration 80c. The lower fill valve 88b remains closed, and the upper fill valve 22b is closed, isolating the lock hopper 18 from the reactor 12. The diverter valve is moved to the diverted configuration D2, which couples the lock hopper 18 to the discharge line 25, permitting discharge of the settled solids via the discharge line 25. After discharge, the system is cycled back to the configuration of FIG. 8A.

FIG. 9 is a flow diagram showing a technique for withdrawing polymer product using a fluidized upflow polymer product withdrawal system coupled to a polymerization reactor. While the technique of FIG. 9 is described with reference to the polymerization system 3 of FIG. 7, and the various states of the upflow polymer product withdrawal system 80a to 80d described with reference to FIGS. 8A to 8D, the technique may be practiced using any suitable system according to the present disclosure.

At step 100, the technique includes opening the upper fill valve 22 and the lower fill valve 88 of the fluidized upflow polymer product withdrawal system 3 to fluidically couple the lock hopper 18 to the reactor 12 through both the upper withdrawal line 84 and the lower withdrawal line 86 (for example, the configuration 80a described with reference to FIG. 8A). A pressure difference between the upper reactor outlet and the lower reactor outlet may be more than 60% of a pressure drop across a fluidized bed pressure in the reactor.

At step 102, the technique further includes, after the opening the upper fill valve 22 and the lower fill valve 88 (100), receiving a fluidized mixture of a powder and a gas from the upper withdrawal line 84 and the lower withdrawal line 86 into the lock hopper 18 and allowing the lock hopper 18 to be pressurized to a reactor pressure. The solids may thus settle in the lock hopper 18 with gases moving to the upper line and reactor.

At step 104, the technique further includes, after the pressurization (102), closing the lower fill valve 88 to isolate the lock hopper 18 from the lower withdrawal line 86, stop fluidization in the lock hopper 18, and to allow polymer product to settle in the lock hopper 18 (for example, the configuration 80b described with reference to FIG. 8B). In some aspects, the lock hopper 18 is substantially completely occupied by settled solids after the settling (104). Steps 102 and 104 may be combined.

At step 106, the technique further includes, after the settling (104), closing the upper fill valve 22 to isolate the lock hopper 18 from the upper withdrawal line 84 and from the reactor 12 (for example, leading to the configuration 80c described with reference to FIG. 8C).

At step 108, the technique further includes, after the isolating (106), discharging the contents of the lock hopper 18 (for example, the configuration 80c described with reference to FIG. 8C). The discharging the contents of the lock hopper 18 (108) may include moving the diverter valve from the withdrawal position D1 to the discharge position D2 to discharge the contents of the lock hopper 18. The system may then return to the configuration of FIG. 8A.

In aspects, the technique further optionally includes, at step 110, after the settling (104), closing the reactor outlet valve 26.

In aspects, the technique further includes repeating one or more of steps 100 to 110 one or more times.

A withdrawn bulk density of material discharged from the fluidized upflow polymer product withdrawal system is greater than or equal to 16 lbs/ft³ when the reactor fluid bulk density is 15 lbs/ft³.

Thus, the fluidized upflow polymer product withdrawal system 80 may be used to advantageously withdraw polymer product from the reactor 12 with repeated withdrawal cycles.

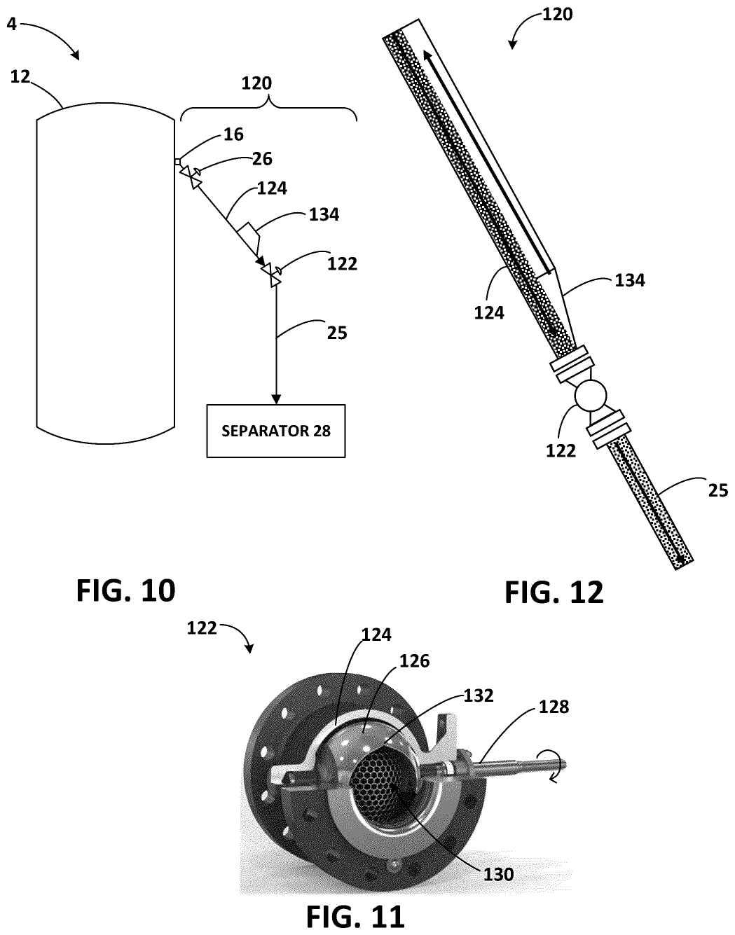

FIG. 10 is a conceptual block diagram showing a polymerization system 4 including a continuous take-off polymer product withdrawal system 120 coupled to a polymerization reactor 12. For example, the system 120 may be coupled to the reactor outlet 16.

The system 120 includes a withdrawal line 124 coupled to and downstream of the reactor outlet 16. The system 4 may include an eructation tube configured to couple a top of the withdrawal line 124 to an above-bed or lower pressure outlet 16 of the reactor 12. In some aspects, the reactor outlet 16 may be below 85% of the fluidized bed height. The withdrawal line 124 may be similar to the withdrawal line 14 described with reference to system 1. The withdrawal line 124 includes at least one non-vertical section, and is absent of any non-self draining regions. The non-vertical section is cylindrical. In some aspects, the withdrawal line 124 consists of the non-vertical section.

In aspects, the withdrawal line 124 is absent of any vertical sections. In some aspects, the withdrawal line is absent of any substantially vertical sections. The withdrawal line 124 may be absent of any bends.

In aspects, the at least one non-vertical section defines a slope relative to a vertical axis greater than or equal to 10 degrees. The slope may be less than or equal to 30 degrees. The slope may be greater than one or both of an angle of repose of the polymer product, or greater than a critical chute angle. The slope may permit carrier gas in the withdrawal line 124 to flow upward and above powder in the withdrawal line 124 flowing downward from the reactor 16.

The system 120 further includes a continuous take-off valve 122 coupled to and downstream of the withdrawal line 124. FIG. 11 is an image showing a partial view of a continuous take-off valve 122 for use in the continuous take-off polymer product withdrawal system 120. To promote flow and reduce or prevent settling or agglomeration in the valve 122, the flow diameter of the continuous-take off valve 122 may be greater than or equal to a flow diameter of the withdrawal line 124. In some aspects, the flow diameter of the continuous-take off valve 122 is the same as that of the withdrawal line 124.

The continuous take-off valve 122 may include a valve housing 124 holding a rotating element 126 rotatable about an axle 128. In some aspects, the rotating element 126 is in the form of a V-ball, as shown in FIG. 11. The valve 122 is open in the configuration shown in FIG. 11, with flow through opening 130. For example, the opening 130 may have a V-shaped peripheral portion defined by the V-ball. If the rotating element 126 is turned in the direction of the arrow, the valve 122 closes by turning the opening 130 to face a closed surface. In some such aspects, the rotating element 126 defines a V-notch 132. The V-notch 132 may establish an initial flow when starting from a closed position and rotating to an open position. The V-notch 132 may be oriented to face a bottom of the withdrawal line 124, toward a portion where settled product flows.

The valve 122 may be adjacent or at an end of the withdrawal line 124. The valve 122 may be inclined along the withdrawal line 124. The system 120 may further include the discharge line 25 coupled to the valve 122, and the separator 28. In aspects, the discharge line 25 may be inclined, for example, at substantially the same slope as a section of the withdrawal line 124.

System 120 may further include an eccentric expander 134 upstream of the continuous take-off valve 122 and coupled to the withdrawal line 124 and configured to transport the powder downward and allow the gas to flow over the powder upward. The eccentric expander 134 varies in a cross-section to allow a varying volume of gas to flow along a length of the eccentric expander 134. In aspects, the eccentric expander 134 has a maximum cross-sectional area from 1 to 4 times a minimum cross-sectional area. A ratio of greater than 4 may result in unmixed areas that tend to make agglomerates. The eccentric expander 134 may extend along an entire length of the withdrawal line 124, or may only partially extend along a length of the withdrawal line 124.

The system 120 may include the reactor outlet valve 26. For example, the reactor outlet valve 26 may be adjacent or at the reactor outlet 16.

FIG. 12 is a conceptual diagram showing an interim stage of product withdrawal in a continuous take-off polymer product withdrawal system 120.

Polymer product, including powder and gas may enter the withdrawal line 124 from the reactor 12 (for example, when reactor outlet valve 26 is opened) with solids settling along the bottom of the withdrawal line 124, and gas returning to the reactor 12 over the top of the powder. The eccentric expander 134 may allow gas to be disengaged from powder into a vapor space where it can flow back towards the reactor 12. The continuous take-off valve 122 is rotated to be at least partially open, to allow the downward withdrawal of polymer product, for example, to the discharge line 25. The line 25 may be vertical, horizontal, or sloped, and may use the entrained gas that is expanded as the pressure is reduced to provide motive force.

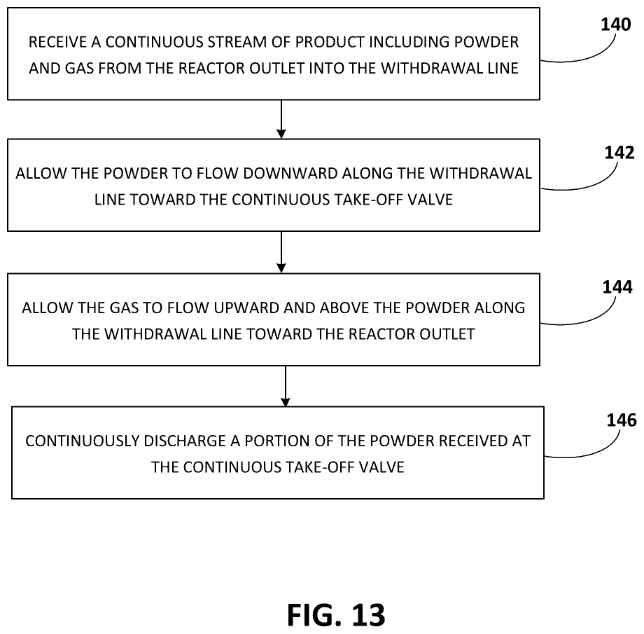

FIG. 13 is a flow diagram showing a technique for withdrawing polymer product using a continuous take-off polymer product withdrawal system coupled 120 to a polymerization reactor 12. At step 140, the technique includes receiving a continuous stream of product including powder and gas from the reactor outlet 16 into the withdrawal line 124. The reactor outlet valve 26, if present, is maintained open.

At step 142, the technique further includes allowing the powder to flow downward along the withdrawal line 124 toward the continuous take-off valve 122. In aspects, a residence time in the withdrawal line 124 may be from 2 seconds to 15 seconds. The residence time is a ratio of the volume of the withdrawal line 124 to the volumetric rate of the stream received from the outlet 16.

At step 144, the technique further includes allowing the gas to flow upward and above the powder along the withdrawal line 122 toward the reactor outlet 16.

At step 148, the technique further includes continuously discharging at least a portion of the powder received at the continuous take-off valve 122.

A withdrawn bulk density of material discharged from the continuous polymer product withdrawal system is greater than 16 lbs/ft³, when the reactor fluid bulk density is 15 lbs/ft³.

Thus, the fluidized upflow polymer product withdrawal system 120 may be used to advantageously withdraw polymer product from the reactor 12 with repeated withdrawal cycles.

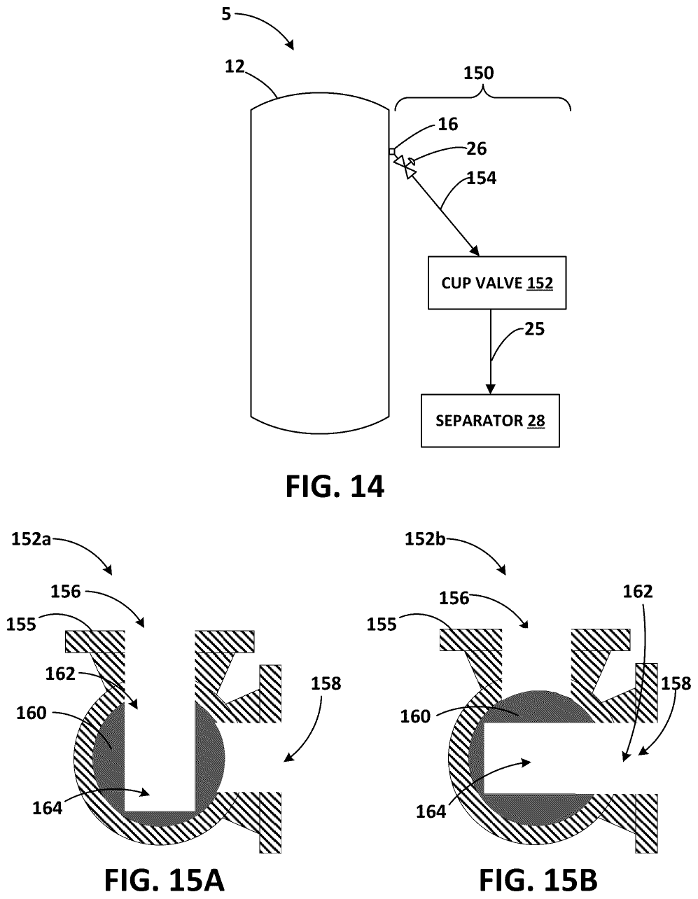

FIG. 14 is a conceptual block diagram showing a polymerization system 5 including a rotating cup polymer product withdrawal system 150 coupled to the polymerization reactor 12. For example, the system 150 may be coupled to the reactor outlet 16. The system 150 may further include an eructation tube configured to couple a top of the withdrawal line 154 to an above-bed or lower pressure outlet 16 of the reactor 12.

The system 150 includes a withdrawal line 154 coupled to and downstream of the reactor outlet 16 configured to discharge a product including a powder and a carrier gas. The withdrawal line 154 may be similar to the withdrawal line 14 described with reference to the system 1. The withdrawal line 154 includes at least one non-vertical section, and is absent of any non-self draining regions.

The withdrawal line 154 may be absent of any vertical sections. The withdrawal line may be absent of any substantially vertical sections. The withdrawal line 154 may be absent of any bends.

The at least one non-vertical section defines a slope relative to a vertical axis greater than or equal to 10 degrees. The slope may be less than or equal to 30 degrees. The slope may be greater than one or both of an angle of repose of the polymer product or a critical chute angle. The slope may permits carrier gas in the withdrawal line 154 to flow upward and above powder in the withdrawal line 154 flowing downward from the reactor 12. The non-vertical section may be cylindrical. In some aspects, the withdrawal line 154 consists of the non-vertical section.

The system 150 further includes a rotating cup valve 152 coupled to and downstream of the withdrawal line 154. FIGS. 15A and 15B are conceptual diagrams showing different stages of product withdrawal in the rotating cup polymer product withdrawal system 5. FIG. 15A is a conceptual diagram showing a rotating cup valve in a receiving configuration 152a. FIG. 15B is a conceptual diagram showing a rotating cup valve in a discharge configuration 152b. Rotating cup valve 152 includes a valve housing 155 defining a receiving opening 156 and a discharge opening 158. Multiple cup valves may be used in association with a single withdrawal line 154.

The valve housing holds a rotatable cup element 160 having a cup opening 162 and a cup chamber 164. The cup element 160 may be formed of a metal or an alloy, or any rigid material capable of chewing through solid polymer aggregates. In the receiving configuration 152a, the cup opening 162 at least partially overlaps with or is substantially aligned with the receiving opening 156 to receive polymer product from the withdrawal line 154 into the cup chamber 164. The cup element 160 is then rotated to the discharge configuration 152b, in which the cup opening 162 at least partially overlaps with or is substantially aligned with the discharge opening 158 to discharge polymer product from the cup chamber 164, for example, into the discharge line 25.

In aspects, a flow diameter of the rotating cup valve 152 is greater than or equal to a flow diameter of the withdrawal line 154. In some aspects, the flow diameter of the rotating cup valve 152 is the same as that of the withdrawal line 154.

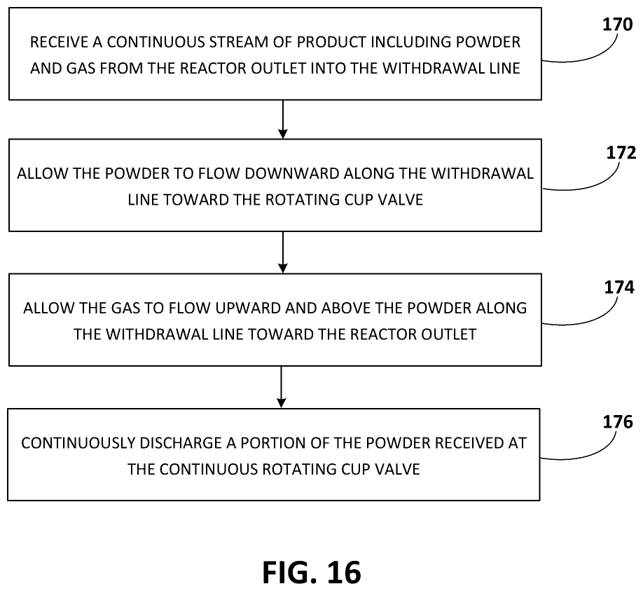

FIG. 16 is a flow diagram showing a technique for withdrawing polymer product using the rotating cup polymer product withdrawal system 150 coupled to a polymerization reactor 12.

At step 170, the technique includes receiving a continuous stream of product including powder and gas from the reactor outlet 16 into the withdrawal line 154.

At step 172, the technique includes allowing the powder to flow downward along the withdrawal line toward the rotating cup valve 152.

At step 174, the technique includes allowing the gas to flow upward and above the powder along the withdrawal line 154 toward the reactor outlet 16.

At step 176, the technique includes continuously discharging a portion of the powder received at the continuous rotating cup valve 152. The continuously discharging may include sequentially rotating the cup valve element 160 between the receiving configuration 152a described with reference to FIG. 15A and the discharge configuration 152b described with reference to FIG. 15B.

Thus, the fluidized upflow polymer product withdrawal system 150 may be used to advantageously withdraw polymer product from the reactor 12 with repeated withdrawal cycles.

The invention is described above with reference to numerous aspects and embodiments, and specific examples. Many variations will suggest themselves to those skilled in the art in light of the above detailed description. All such obvious variations are within the full intended scope of the appended claims. Other aspects of the invention can include, but are not limited to, the following aspects. Many aspects are described as “including” certain components or steps, but alternatively, can “consist essentially of” or “consist of” those components or steps unless specifically stated otherwise.

### Aspects

1. A downflow polymer product withdrawal system including:
   a withdrawal line coupled to and downstream of a reactor outlet configured to collect and discharge a product including a powder and a carrier gas, the withdrawal line defining a downflow volume, the withdrawal line including at least one downward sloped descending section, the withdrawal line being absent of any non-self draining regions;
   a lock hopper coupled to and downstream of the withdrawal line, the lock hopper defining a chamber configured to receive at least a portion of the powder and the carrier gas from the withdrawal line;
   a fill valve between the withdrawal line and the lock hopper; and a discharge valve downstream of the lock hopper.
2. The system of aspect 1, where the downflow volume is greater than 80% of a volume of the lock hopper.
3. The system of aspect 1, where the downflow volume is greater than 90% of the volume of the lock hopper.
4. The system of aspect 3, where the downflow volume is 100% or less of the volume of the lock hopper.
5. The system of aspect 4, where the downflow volume is substantially 100% of the volume of the lock hopper.
6. The system of any of aspects 1 to 5, where the withdrawal line is absent of any vertical sections.
7. The system of any of aspects 1 to 6, where the at least one downward sloped descending section defines a slope relative to a vertical axis greater than or equal to 10 degrees.
8. The system of aspect 7, where the slope is less than or equal to 30 degrees.
9. The system of aspect 7, where the slope is greater than an angle of repose of the polymer product.
10. The system of aspect 7, where the slope is greater than a critical chute angle.
11. The system of any of aspects 7 to 10, where the slope permits carrier gas in the withdrawal line to flow upward and above powder in the withdrawal line flowing downward from the reactor.
12. The system of any of aspects 1 to 11, where the downward sloped descending section is cylindrical.
13. The system of any of aspects 1 to 12, where the withdrawal line consists of the downward sloped descending section.
14. The system of any of aspects 1 to 13, where the withdrawal line is absent of any bends.
15. The system of any of aspects 1 to 14, where the withdrawal line is absent of any substantially vertical sections.
16. The system of any of aspects 1 to 15, where the lock hopper includes a cylindrical top section joined to a conical bottom section and defines an axis extending through both the cylindrical top section and the conical bottom section.
17. The system of aspect 16, where the lock hopper axis extends along a vertical axis.
18. The system of any of aspects 1 to 17, where one or both of the fill valve and the discharge valve extend along a vertical axis.
19. The system of any of aspects 1 to 18, where a flow diameter of one or both of the fill valve and the discharge valve is greater than or equal to a flow diameter of the withdrawal line.
20. The system of any of aspects 1 to 19, further including a discharge line coupled to the discharge valve, where the discharge line is absent of bends.
21. The system of any of aspects 1 to 20, further including an eructation tube configured to couple a top of the withdrawal line to an above-bed or lower pressure outlet of the reactor.
22. A polymerization system including:
   a polymerization reactor having a reactor outlet configured to discharge a product including a powder and a carrier gas, where the powder includes a polymer; and
   the downflow polymer product withdrawal system of any of aspects 1 to 21, coupled to the reactor outlet.
23. A method of operating the polymerization system of aspect 22, the method including: opening a fill valve of the downflow polymer product withdrawal system to fluidically couple a lock hopper to the reactor through a withdrawal line;
   after the opening the fill valve, receiving a plug including powder and gas from the withdrawal line into the lock hopper;
   after receiving the plug, allowing the lock hopper to be pressurized with gas received from the reactor through the withdrawal line to a reactor pressure;
   after the pressurization, allowing powder from the withdrawal line to continue to settle into the lock hopper for a predetermined settling time;
   after the settling, closing the fill valve to isolate the lock hopper from the withdrawal line and from the reactor; and
   after the closing the fill valve, opening the discharge valve to discharge the contents of the lock hopper.
24. The method of aspect 23, further including allowing the plug to form adjacent the closed fill valve in the withdrawal line by receiving a portion of powder and gas from the reactor.
25. The method of aspect 24, where the plug has a solids concentration from 60% to 150% by weight of a solids concentration in the reactor.
26. The method of any of aspects 23 to 25, where, after the settling, the lock hopper has a solids concentration greater than a solids concentration in the reactor.
27. The method of aspect 25, further including repeating the steps of aspect 23 one or more times.
28. The method of aspect 27, where a withdrawn bulk density of material discharged from the downflow polymer product withdrawal system is greater than 16 lbs/ft³ when the reactor fluid bulk density is 15 lbs/ft³.
29. An upflow polymer product withdrawal system including:
   a withdrawal line coupled to and downstream of a reactor outlet configured to collect and discharge a product including a powder and a carrier gas, the withdrawal line defining an upflow volume, the withdrawal line including at least one non-vertical section, the non-vertical section including at least one upward sloped ascending section and at least one downward sloped descending section, the upward sloped ascending section being downstream of the reactor, the downward sloped descending section being downstream of the upward sloped ascending section, the withdrawal line being absent of any non-self draining regions;
   a lock hopper coupled to and downstream of the at least one downward sloped descending section of the withdrawal line, the lock hopper defining a chamber configured to receive at least a portion of the powder and the carrier gas from the withdrawal line;
   a fill valve between the withdrawal line and the lock hopper; and
   a discharge valve downstream of the lock hopper.
30. The system of aspect 29, where the upflow volume is only within the at least one downward sloped descending section.
31. The system of aspect 29 or 30, where the upflow volume is less than or equal to 50% of a volume of the lock hopper.
32. The system of any of aspects 29 to 31, where the upflow volume is greater than 25% of the volume of the lock hopper.
32. The system of aspect 29 to 30, where the upflow volume is in a range from 25% to 50% of the volume of the lock hopper.
34. The system of any of aspects 29 to 33, where the withdrawal line is absent of any vertical sections.
35. The system of any of aspects 29 to 34, where the at least one upward sloped ascending section defines an ascending slope relative to a vertical axis greater than or equal to 10 degrees.
36. The system of any of aspects 29 to 35, where the at least one downward sloped descending section defines a descending slope relative to a vertical axis greater than or equal to 10 degrees.
37. The system of aspect 36, where one or both of the ascending slope and the descending slope is less than or equal to 30 degrees.
38. The system of aspect 36 or 37, where one or both of the ascending slope and the descending slope is greater than a critical chute angle.
39. The system of any of aspects 36 to 38, where one or both of the ascending slope and the descending slope is greater than an angle of repose of the polymer product.
40. The system of any of aspects 36 to 39, where the ascending slope is substantially equal to the descending slope.
41. The system of any of aspects 36 to 40, where the descending slope permits carrier gas in the withdrawal line to flow upward and above powder in the withdrawal line flowing downward from the reactor.
42. The system of any of aspects 29 to 41, where the sloped sections are cylindrical.
43. The system of any of aspects 29 to 42, where the withdrawal line consists of the sloped sections.
44. The system of any of aspects 29 to 43, where the sloped sections are absent of any bends.
45. The system of any of aspects 29 to 44, where the withdrawal line is absent of any substantially vertical sections.
46. The system of any of aspects 29 to 45, where the lock hopper includes a cylindrical top section joined to a conical bottom section and defines an axis extending through both the cylindrical top section and the conical bottom section.
47. The system of aspect 46, where the lock hopper axis extends along a vertical axis.
48. The system of any of aspects 29 to 47, where the discharge valve extends along a vertical axis, and where the fill valve is inclined relative to the vertical axis.
49. The system of any of aspects 29 to 48, where a flow diameter of one or both of the fill valve and the discharge valve is greater than or equal to a flow diameter of the withdrawal line.
50. The system of any of aspects 29 to 49, further including a discharge line coupled to the discharge valve, where the discharge line is absent of bends.
51. The system of any of aspects 29 to 50, further including an eructation tube configured to couple a top of the withdrawal line to an above-bed or lower pressure outlet of the reactor.
52. A polymerization system including:
   a polymerization reactor having a reactor outlet configured to discharge a product including a powder and a carrier gas, where the powder includes a polymer; and
   the upflow polymer product withdrawal system of any of aspects 29 to 51, coupled to the reactor outlet.
53. A method of operating the polymerization system of aspect 52, the method including:
   opening a fill valve of the upflow polymer product withdrawal system to fluidically couple a lock hopper to the reactor through a withdrawal line;
   after the opening the fill valve, receiving a mixture of a powder and a gas from the withdrawal line into the lock hopper and allowing the lock hopper to be pressurized to a reactor pressure;
   after the pressurization, allowing powder from the withdrawal line to continue to settle into the lock hopper for a predetermined settling time;
   after the settling, closing the fill valve and the equalization valve to isolate the lock hopper from the withdrawal line and from the reactor; and
   after the closing the fill valve, opening the discharge valve to discharge the contents of the lock hopper.
54. The method of aspect 53, where after the settling, the equalization valve is closed before the fill valve is closed.
55. The method of aspects 53 or 54, further including, after the setting, closing the second equalization valve.
56. The method of any of aspects 53 to 55, where the mixture has a solids concentration equal to or greater than a solids concentration in the reactor.
57. The method of any of aspects 53 to 56, further including repeating the steps of aspect 53 one or more times.
58. The method of aspect 57, where a withdrawn bulk density of material discharged from the upflow polymer product withdrawal system is greater than or equal to 16 lbs/ft³.
59. The method of aspect 57, where a withdrawn bulk density of material discharged from the upflow polymer product withdrawal system is greater than or equal to 16 lbs/ft³ when a reactor fluid bulk density is 15 lbs/ft³.
60. The method of any of aspects 53 to 59, where the lock hopper is substantially completely occupied by settled solids after the settling.
61. A fluidized upflow polymer product withdrawal system including:
   an upper withdrawal line coupled to an upper reactor outlet configured to collect and discharge a product including a powder and a carrier gas, the upper withdrawal line defining an upper upflow volume, the upper withdrawal line including at least one descending non-vertical section, the upper withdrawal line being absent of any non-self draining regions;
   a lock hopper coupled to and downstream of the upper withdrawal line, the lock hopper defining a chamber configured to receive at least a portion of the powder and the carrier gas from the upper withdrawal line;
   a lower withdrawal line coupled to and downstream of the lock hopper, the lower withdrawal line being coupled to a lower reactor outlet configured to collect and discharge the product, the lower withdrawal line including at least one ascending section;
   at least one upper fill valve between the upper withdrawal line and the lock hopper;
   a lower filler valve between the lock hopper and the lower withdrawal line; and
   a discharge valve for discharging the contents of the lock hopper.
62. The system of aspect 61, where the upper reactor outlet is positioned from 60% to 100% of a fluidized bed height of the reactor.
63. The system of aspects 61 or 62, where the lower reactor outlet is positioned from 0% to 30% of the fluidized bed height of the reactor.
64. The system of any of aspects 61 to 63, further including a reactor outlet valve between the reactor outlet and the upper withdrawal line.
65. The system of any of aspects 61 to 64, where the upper upflow volume is less than or equal to 50% of a volume of the lock hopper.
66. The system of aspect 65, where the upper upflow volume is greater than 25% of the volume of the lock hopper.
67. The system of any of aspects 61 to 66, where the upper withdrawal line is absent of any vertical sections.
68. The system of any of aspects 61 to 67, where the descending non-vertical section defines a descending slope relative to a vertical axis greater than or equal to 10 degrees.
69. The system of aspect 69, where the descending slope is less than or equal to 30 degrees.
70. The system of aspect 68 or 69, where the descending slope is greater than a critical chute angle.
71. The system of any of aspects 68 to 70, where the descending slope is greater than an angle of repose of the polymer product.
72. The system of any of aspects 61 to 71, where the ascending section is vertical or sloped at an ascending angle from 0 degrees to 20 degrees from the vertical.
73. The system of any of aspects 61 to 72, where one or both of the ascending section and the descending non-vertical section are cylindrical.
74. The system of any of aspects 61 to 73, where one or both of the ascending section and the descending non-vertical section are absent of any bends.
75. The system of any of aspects 61 to 74, where the upper withdrawal line is absent of any substantially vertical sections.
76. The system of any of aspects 61 to 75, where the lock hopper includes a cylindrical top section joined to a conical bottom section and defines an axis extending through both the cylindrical top section and a conical bottom section.
77. The system of aspect 76, where one or both of the lock hopper axis and the upper fill valve extends along a vertical axis.
78. The system of any of aspects 61 to 77, where a flow diameter of the upper fill valve is greater than or equal to a flow diameter of the upper withdrawal line and a flow diameter of the lower fill valve is greater than or equal to a flow diameter of the lower withdrawal line.
79. The system of any of aspects 61 to 78, where the discharge line is absent of bends.
80. The system of any of aspects 61 to 79, further including an eructation tube configured to couple a top of the withdrawal line to an above-bed or lower pressure outlet of the reactor.
81. The system of any one of aspects 61 to 80, where the discharge valve is a diverter valve coupled to and downstream of the lock hopper, the diverter valve being coupled to a downstream discharge line, the diverter valve having a withdrawal position coupling the lock hopper to the lower withdrawal line and a discharge position coupling the lock hopper to the downstream discharge line.
82. A polymerization system including:
   a polymerization reactor having an upper reactor outlet and a lower reactor outlet configured to discharge a product including a powder and a carrier gas, where the powder includes a polymer; and
   the fluidized upflow polymer product withdrawal system of any of aspects 61 to 81, coupled between the upper reactor outlet and the lower reactor outlet.
83. A method of operating the polymerization system of aspect 82, the method including:
   opening an upper fill valve and a lower fill valve of the fluidized upflow polymer product withdrawal system to fluidically couple a lock hopper to the reactor through both the upper withdrawal line and the lower withdrawal line;
   after the opening the upper fill valve and the lower fill valve, receiving a fluidized mixture of a powder and a gas from the upper withdrawal line and the lower withdrawal line into the lock hopper and allowing the lock hopper to be pressurized to a reactor pressure;
   after the pressurization, closing the lower fill valve to isolate the lock hopper from the lower withdrawal line, stop fluidization in the lock hopper, and to allow polymer product to settle in the lock hopper;
   after the settling, closing the upper fill valve to isolate the lock hopper from the upper withdrawal line and from the reactor; and
   after the isolating, discharging the contents of the lock hopper.
84. The method of aspect 83, where discharging the contents of the lock hopper includes moving the diverter valve from the withdrawal position to the discharge position to discharge the contents of the lock hopper.
85. The method of aspect 83 or 84, further including, after the settling, closing the reactor outlet valve.
86. The method of aspect 83 or 84, further including repeating the steps of aspect 83 one or more times.
87. The method of aspect 86, where a withdrawn bulk density of material discharged from the fluidized upflow polymer product withdrawal system is greater than or equal to 16 lbs/ft³ when a reactor fluid bulk density is 15 lbs/ft³.
88. The method of any of aspects 83 to 87, where a pressure difference between the upper reactor outlet and the lower reactor outlet is more than 60% of a fluidized bed pressure in the reactor.
89. The method of any of aspects 83 to 87, where a diameter of the lock hopper is from 1.0 to 1.5 times a diameter of the upper withdrawal line.
90. The method of any of aspects 83 to 89, where the lock hopper is substantially completely occupied by settled solids after the settling.
91. A continuous polymer product withdrawal system including:
   a withdrawal line coupled to and downstream of a reactor outlet configured to discharge a product including a powder and a carrier gas, the withdrawal line including at least one non-vertical section, the withdrawal line being absent of any non-self draining regions; and
   a continuous take-off valve coupled to and downstream of the withdrawal line.
92. The system of aspect 91, where the withdrawal line is absent of any vertical sections.
93. The system of aspects 91 or 92, where the at least one non-vertical section defines a slope relative to a vertical axis greater than or equal to 10 degrees.
94. The system of aspect 93, where the slope is less than or equal to 30 degrees.
95. The system of aspect 93, where the slope is greater than an angle of repose of the polymer product.
96. The system of aspect 94, where the slope is greater than a critical chute angle.
97. The system of any of aspects 93 to 96, where the slope permits carrier gas in the withdrawal line to flow upward and above powder in the withdrawal line flowing downward from the reactor.
98. The system of any of aspects 91 to 97, where the non-vertical section is cylindrical.
99. The system of any of aspects 91 to 98, where the withdrawal line consists of the non-vertical section.
100. The system of any of aspects 91 to 99, where the withdrawal line is absent of any bends.
101. The system of any of aspects 91 to 100, where the withdrawal line is absent of any substantially vertical sections.
102. The system of any of aspects 91 to 101, where a flow diameter of the continuous-take off valve is greater than or equal to a flow diameter of the withdrawal line.
103. The system of any of aspects 91 to 102, further including an eructation tube configured to couple a top of the withdrawal line to an above-bed or lower pressure outlet of the reactor.
104. The system of any of aspects 91 to 103, where the reactor outlet is below 85% of the fluidized bed height.
105. The system of any of aspects 91 to 104, further including an eccentric expander upstream of the continuous take-off valve and coupled to the withdrawal line and configured to transport the powder downward and allow the gas to flow over the powder upward.
106. The system of aspect 105, where the eccentric expander has a maximum cross-sectional area from 1 to 4 times a minimum cross-sectional area.
107. A polymerization system including:
   a polymerization reactor having a reactor outlet configured to discharge a product including a powder and a carrier gas, where the powder includes a polymer; and
   the continuous polymer product withdrawal system of any of aspects 91 to 106, coupled to the reactor outlet.
108. A method of operating the polymerization system of aspect 107, the method including: receiving a continuous stream of product including powder and gas from the reactor outlet into the withdrawal line;
   allowing the powder to flow downward along the withdrawal line toward the continuous take-off valve;
   allowing the gas to flow upward and above the powder along the withdrawal line toward the reactor outlet;
   continuously discharging a portion of the powder received at the continuous take-off valve.
109. The method of aspect 108, where a residence time in the withdrawal line is from 2 seconds to 15 seconds.
110. The method of aspects 108 or 109, where a withdrawn bulk density of material discharged from the continuous polymer product withdrawal system is greater than 16 lbs/ft³ when a reactor fluid bulk density is 15 lbs/ft³.
111. A continuous polymer product withdrawal system including:
   a withdrawal line coupled to and downstream of a reactor outlet configured to discharge a product including a powder and a carrier gas, the withdrawal line including at least one non-vertical section, the withdrawal line being absent of any non-self draining regions; and
   a rotating cup valve coupled to and downstream of the withdrawal line.
112. The system of aspect 111, where the withdrawal line is absent of any vertical sections.
113. The system of aspects 111 or 112, where the at least one non-vertical section defines a slope relative to a vertical axis greater than or equal to 10 degrees.
114. The system of aspect 113, where the slope is less than or equal to 30 degrees.
115. The system of aspect 113, where the slope is greater than an angle of repose of the polymer product.
116. The system of aspect 114, where the slope is greater than a critical chute angle.
117. The system of any of aspects 113 to 116, where the slope permits carrier gas in the withdrawal line to flow upward and above powder in the withdrawal line flowing downward from the reactor.
118. The system of any of aspects 111 to 117, where the non-vertical section is cylindrical.
119. The system of any of aspects 111 to 118, where the withdrawal line consists of the non-vertical section.
120. The system of any of aspects 111 to 119, where the withdrawal line is absent of any bends.
121. The system of any of aspects 111 to 120, where the withdrawal line is absent of any substantially vertical sections.
122. The system of any of aspects 111 to 121, where a flow diameter of the rotating cup valve is greater than or equal to a flow diameter of the withdrawal line.
123. The system of any of aspects 111 to 122, further including an eructation tube configured to couple a top of the withdrawal line to an above-bed or lower pressure outlet of the reactor.
124. A polymerization system including:
   a polymerization reactor having a reactor outlet configured to discharge a product including a powder and a carrier gas, where the powder includes a polymer; and
   the continuous polymer product withdrawal system of any of aspects 111 to 123, coupled to the reactor outlet.
125. A method of operating the polymerization system of aspect 124, the method including:
   receiving a continuous stream of product including powder and gas from the reactor outlet into the withdrawal line;
   allowing the powder to flow downward along the withdrawal line toward the rotating cup valve;
   allowing the gas to flow upward and above the powder along the withdrawal line toward the reactor outlet;
   continuously discharging a portion of the powder received at the continuous rotating cup valve.

We claim:

1. A downflow polymer product withdrawal system comprising:
a withdrawal line coupled to and downstream of a reactor outlet configured to collect and discharge a product comprising a powder and a carrier gas, the withdrawal line defining a downflow volume, the withdrawal line comprising at least one downward sloped descending section, the withdrawal line being absent of any non-self draining regions;
a lock hopper coupled to and downstream of the withdrawal line, the lock hopper defining a chamber configured to receive at least a portion of the powder and the carrier gas from the withdrawal line;
a fill valve between the withdrawal line and the lock hopper; and
a discharge valve downstream of the lock hopper.

2. The system of claim 1, wherein the downflow volume is greater than 80% of a volume of the lock hopper.

3. The system of claim 1, wherein the withdrawal line is absent of any vertical sections.

4. The system of claim 1, wherein the at least one downward sloped descending section defines a slope relative to a vertical axis greater than or equal to 10 degrees.

5. The system of claim 4, wherein the slope is greater than one or both of an angle of repose of the polymer product or a critical chute angle.

6. The system of claim 4, wherein the slope permits carrier gas in the withdrawal line to flow upward and above powder in the withdrawal line flowing downward from the reactor.

7. The system of claim 1, wherein the downward sloped descending section is cylindrical.

8. The system of claim 1, wherein the withdrawal line consists of the downward sloped descending section.

9. The system of claim 1, wherein the withdrawal line is absent of any bends.

10. The system of claim 1, wherein the lock hopper comprises a cylindrical top section joined to a conical bottom section and defines an axis extending through both the cylindrical top section and the conical bottom section.

11. The system of claim 1, wherein one or more of the lock hopper axis, the fill valve, and the discharge valve extend along a vertical axis.

12. The system of claim 1, wherein a flow diameter of one or both of the fill valve and the discharge valve is greater than or equal to a flow diameter of the withdrawal line.

13. The system of claim 1, further comprising a discharge line coupled to the discharge valve, wherein the discharge line is absent of bends.

14. The system of claim 1, further comprising an eructation tube configured to couple a top of the withdrawal line to an above-bed or lower pressure outlet of the reactor.

15. A polymerization system comprising:
a polymerization reactor having a reactor outlet configured to discharge a product comprising a powder and a carrier gas, wherein the powder comprises a polymer; and
the downflow polymer product withdrawal system of claim 1, coupled to the reactor outlet.

16. A method of operating a polymerization system including a polymerization reactor and a downflow polymer product withdrawal system coupled to a reactor outlet of the polymerization reactor, the method comprising:
opening a fill valve of the downflow polymer product withdrawal system to fluidically couple a lock hopper to the polymerization reactor through a withdrawal line, the withdrawal line comprising at least one downward sloped descending section, the withdrawal line being absent of any non-self draining regions;
after the opening the fill valve, receiving a plug comprising powder and gas from the withdrawal line into the lock hopper;
after receiving the plug, allowing the lock hopper to be pressurized with gas received from the reactor through the withdrawal line to a reactor pressure;
after the pressurization, allowing powder from the withdrawal line to continue to settle into the lock hopper for a predetermined settling time;
after the settling, closing the fill valve to isolate the lock hopper from the withdrawal line and from the reactor; and
after the closing the fill valve, opening the discharge valve to discharge the contents of the lock hopper.

17. The method of claim 16, further comprising allowing the plug to form adjacent the closed fill valve in the withdrawal line by receiving a portion of powder and gas from the reactor.

18. The method of claim 17, wherein the plug has a solids concentration from 60% to 150% by weight of a solids concentration in the reactor.

19. The method of claim 16, further comprising repeating steps thereof one or more times.

20. The method of claim 19, wherein a withdrawn bulk density of material discharged from the downflow polymer product withdrawal system is greater than 16 lbs/ft³ when a reactor fluid bulk density is 15 lbs/ft³.
